(19) United States
(12) Patent Application Publication
(10) Pub. No.: US 2019/0352960 A1
(43) Pub. Date: Nov. 21, 2019

(54) Composite Sash and Frame for Windows and Doors

(71) Applicant: Edward J. Page, Brewster, NY (US)

(72) Inventor: Edward J. Page, Brewster, NY (US)

(21) Appl. No.: 16/307,226

(22) PCT Filed: Jul. 22, 2017
(86) PCT No.: PCT/IB2017/054451

§ 371 Date: Dec. 5, 2018

Related U.S. Application Data
(60) Provisional application No. 62/354,521, filed on Jun. 24, 2016.

(51) Int. Cl. E06B 3/263; E06B 3/30

(52) U.S. Cl. CPC E06B 3/26341; E06B 3/325; E06B 3/302

(57) ABSTRACT

A composite sash and frame for windows and doors uses a sash assembly, a frame head, a frame sill and a frame jamb to thermally maximize structural integrity, prevent thermal transfer, and increase aesthetic appeal. The composite sash and frame for windows and doors uses a two-sided system. The first side is constructed from rigid durable materials that are designed to withstand corrosion and is positioned on the exterior surface of a building. The second side is constructed from aesthetically appealing thermally isolating materials and is positioned on the interior surface of the building. The sash assembly, the frame head, the frame sill, and the frame jamb are all constructed using this two-sided architecture, and are thus specifically designed to withstand corrosion and damage while satisfying the user's aesthetic requirements.

The current application is a 371 of international Patent Cooperation Treaty (PCT) application PCTIB2017/054451 filed on Jul. 22, 2017.

### FIELD OF THE INVENTION

The present invention relates generally to a multicomponent window and door frame. More specifically, the present invention relates to a window and door frame that employs multiple materials to resist damage, increase structural integrity, prevent thermal transfer, and provide an appealing aesthetic.

### BACKGROUND OF THE INVENTION

The present invention is a window and door system composed of a hybrid frame material and an integral locking system as part of the framing system. The hybrid framing material creates an unequaled thin profile in face dimension with superior thermal insulating, sound deadening and strength properties over traditional systems of any single material.

The window and door industry is segmented into three principle groups by framing material: wood, plastic and metal. Each of them have strengths and weaknesses. To overcome some of those weaknesses cladding of one material with another is sometimes used. Most commonly aluminum or plastic cladding is often used to clad wood windows whose exteriors do not hold up well to weathering and sun exposure. In the case of cladding, if the window is principally wood, for example, with a protective covering to certain benefits are gained, but is still primarily a wood window. The hybrid framing material described here uses wood and metal, but not so as to be able to describe it principally as one or the other. The synergy of the two materials create a new structure that uses the benefits of each at different times to provide structure, beauty and functionality in the narrowest form possible.

### BRIEF DESCRIPTION OF THE DRAWINGS

FIG. 1 is an isometric perspective view of the present invention.

FIG. 2 is a front view of the present invention.

FIG. 3 is a sectional view of the present invention taken along line 3-3 in FIG. 2.

FIG. 4 is a detailed view of the present invention taken along line 4-4 in FIG. 3.

FIG. 5 is a detailed view of the present invention taken along line 5-5 in FIG. 3.

FIG. 6 is a front view of the present invention.

FIG. 7 is a sectional view of the present invention taken along line 7-7 in FIG. 6.

FIG. 8 a detailed view of the present invention taken along line 8-8 in FIG. 7.

FIG. 9 is an exploded view of the present invention.

FIG. 10 is side view of the internal cremone used in the present invention.

FIG. 11 is side view of the internal cremone used in the first alternative embodiment of the present invention.

### DETAIL DESCRIPTIONS OF THE INVENTION

All illustrations of the drawings are for the purpose of describing selected versions of the present invention and are not intended to limit the scope of the present invention.

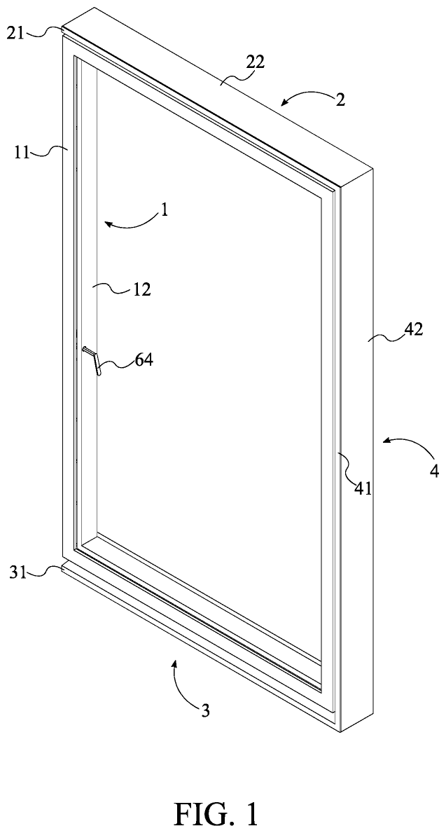

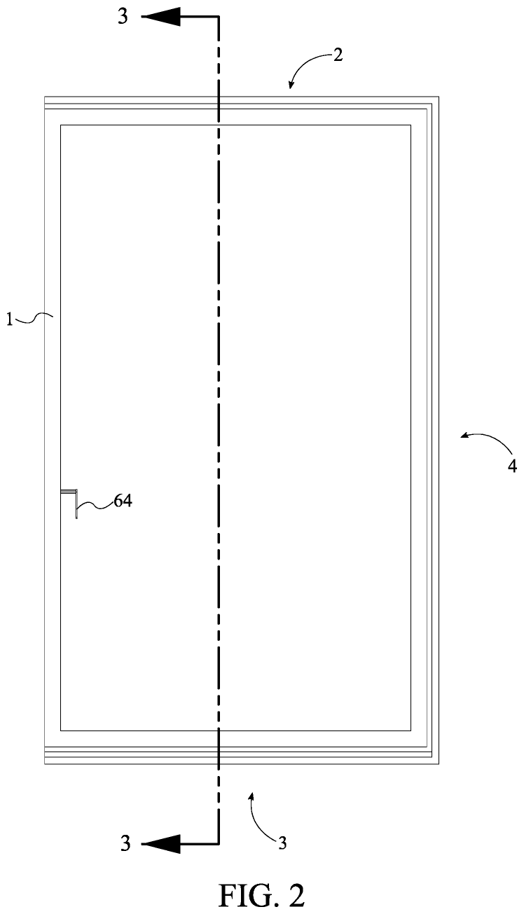

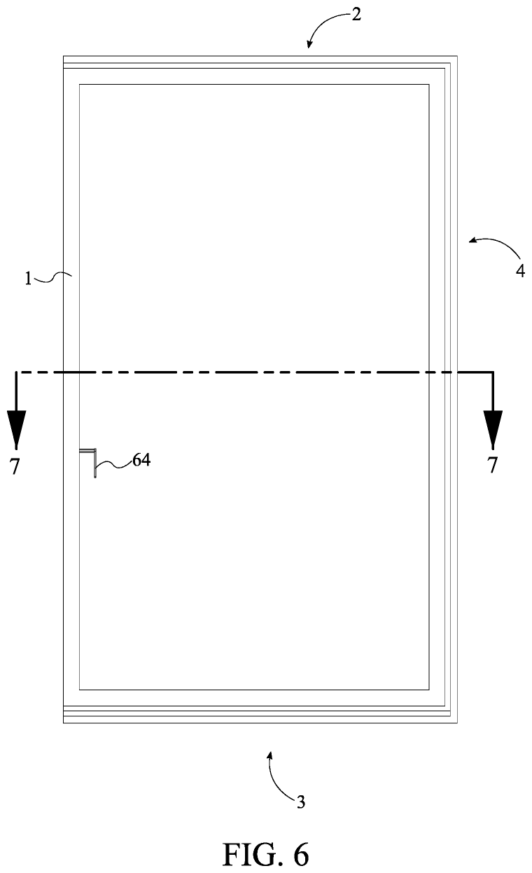

As can be seen in FIG. 1 through FIG. 11, the present invention, the composite sash and frame for windows and doors, is designed to make use of durable weather-resistant materials on the exterior sides of windows and doors. Additionally, the present invention is designed to use aesthetically pleasing and thermally isolating materials on the interior sides of the windows and doors. To accomplish this, the sash, the head, the sill, and the jambs are all constructed in two pieces. The first piece being the durable exterior-facing side and the second piece being the aesthetic interior-facing side. In light of this, the present invention is an assembly that uses multiple materials to increase the strength and durability of a window or door without decreasing the aesthetic appeal of the window or door. Specifically, the use of multiple materials enables the present invention to combine the thermally isolating and decorative properties of wood with the structural benefits of steel. In addition to structural integrity, thermal isolation, and aesthetic appeal, the present invention makes use of an integrated locking mechanism that can be used to unobtrusively lock the present invention in place without the need for an independent locking system.

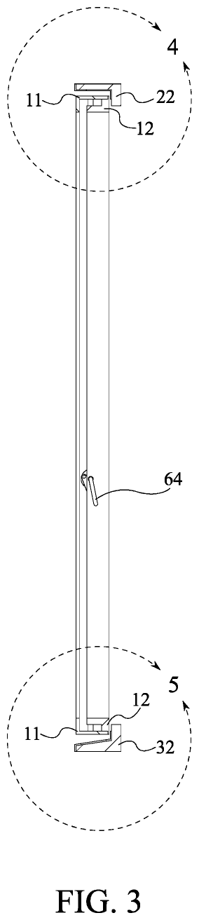

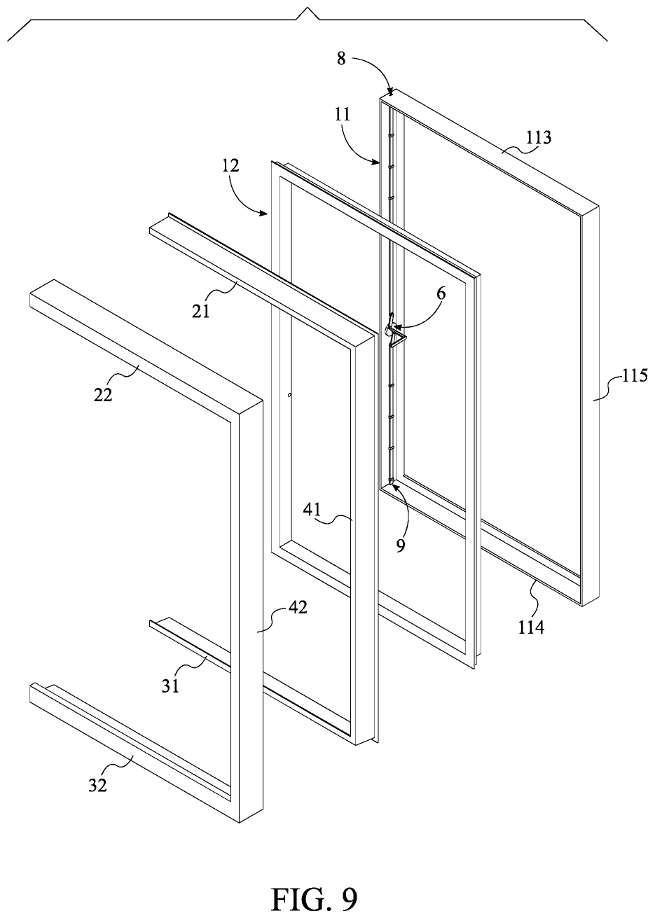

As can be seen in FIG. 1, FIG. 3, and FIG. 9, to accomplish the above-described functionalities, the present invention comprises a sash assembly 1, a frame head 2, a frame sill 3, and a frame jamb 4. The sash assembly 1 is a multicomponent frame that is used to retain a glass pane of a window or door in a desired position while being strong enough to withstand the dynamic forces of being a freely moving element. To accomplish this, the sash assembly 1 comprises an external sash frame 11 and a thermal-stop glazing bead frame 12. The external sash frame 11 is the durable exterior-facing piece of the sash assembly 1 that is used to provide the structural support for the sash assembly 1. Conversely, the thermal-stop glazing bead frame 12 is the interior-facing piece of the sash assembly 1 that holds the glass pane in position while preventing thermal transfer through the sash assembly 1. The frame head 2 is the upper rail of the window or door frame that is used to hold the sash assembly 1 in place. As such, the frame head 2 comprises an exterior head cover 21 and an interior head member 22. The exterior head cover 21 is the durable exterior-facing piece of the frame head 2 that is used to provide the structural support for the frame head 2. Conversely, the interior head member 22 is the interior facing piece of the frame head 2 that increases the aesthetic appeal of the present invention. Similarly, the frame sill 3 is the bottom rail of the window or door frame that is used to hold the sash assembly 1 in place. As such, the frame sill 3 comprises an exterior sill cover 31 and an interior sill member 32. The exterior sill cover 31 is the durable exterior-facing piece of the frame sill 3 that is used to provide the structural support for the frame sill 3. Conversely, the interior sill member 32 is the interior facing piece of the frame sill 3 that increases the aesthetic appeal of the present invention. Likewise, the frame jamb 4 is the bottom rail of the window or door frame that is used to hold the sash assembly 1 in place. As such, the frame jamb 4 comprises an exterior jamb cover 41 and an interior jamb member 42. The exterior jamb cover 41 is the durable exterior-facing piece of the frame jamb 4 that is used to provide the structural support for the frame jamb 4. Conversely, the interior jamb member 42 is the interior facing piece of the frame jamb 4 that increases the aesthetic appeal of the present invention. In the preferred embodiment of the present invention, the thermal-stop glazing bead frame 12, the interior head member 22, the interior sill member 32, and the interior jamb member 42 are made of wood. Additionally, in the preferred embodiment of the present invention, the external sash frame 11, the exterior head cover 21, the exterior sill cover 31, and the exterior jamb cover 41 are made of steel.

As can be seen in FIG. 1, FIG. 3, and FIG. 9, the sash assembly 1 makes use of a uniquely shaped external sash frame 11 that is designed to maximize strength while minimizing thickness. As such, the thermal-stop glazing bead is mounted within the external sash frame 11. Thus positioned, the external sash frame 11 is able to support the pane of glass for the window or door while the glazing bead retains the pane of glass within the sash assembly 1. Moreover, a glass-receiving gap 13 is integrated in between the external sash frame 11 and the thermal-stop glazing bead frame 12. As a result, the pane of glass can be fixedly sandwiched between the external sash frame 11 and the thermal-stop glazing bead frame 12. Expounding on this description, the external sash frame 11 can be seen as a rectangular frame that the pane of glass is placed into. Additionally, the thermal-stop glazing bead frame 12 can be seen as a rectangular structure that is positioned around the perimeter of the pane of glass. Thus positioned, the thermal-stop glazing bead frame 12 is used to hold the pane of glass in position within the external sash frame 11. This configuration enables the external sash frame 11 to support the pane of glass and the thermal-stop glazing bead frame 12. Furthermore, this configuration enables the thermal-stop glazing bead frame 12 to thermally isolate the interior of a building from the exterior environment that is adjacent to the external sash frame 11.

As can be seen in FIG. 1, FIG. 3, and FIG. 9, while the sash assembly 1 functions as the frame that holds the pane of glass in position within the window or door, the frame head 2, the frame sill 3, and the frame jamb 4 form the structure that connects the sash assembly 1 to the building structure into which the window or door is integrated. To accomplish this, the exterior head cover 21 is mounted adjacent to a first lateral surface 113 of the external sash frame 11. To accomplish this, the frame head 2 is mounted adjacent to a first lateral surface 113 of the external sash frame 11. Consequently, the frame head 2 is able to function as a durable and weatherproof support structure that forms the upper rail of the frame around the sash assembly 1. Similarly, the frame sill 3 is mounted adjacent to a second lateral surface 114 of the external sash frame 11. Consequently, the frame sill 3 is able to function as a durable and weatherproof support structure that forms the bottom rail of the frame around the sash assembly 1. Likewise, the frame jamb 4 is mounted adjacent to a third lateral surface 115 of the external sash frame 11. Consequently, the frame jamb 4 is able to function as a durable and weatherproof support structure that forms the vertical support beam of the frame around the sash assembly 1.

As can be seen in FIG. 1, FIG. 3, and FIG. 9, the frame head 2 is manufactured as a multicomponent assembly that promotes durability, thermal insulation, and aesthetic desirability of the present invention. To accomplish this, the exterior head cover 21 is mounted adjacent to a first lateral surface 113 of the external sash frame 11. Consequently, the exterior head cover 21 is able to function as a durable and weatherproof support structure that forms the upper rail for the exterior portion of the frame around the sash assembly 1. The interior head member 22 is mounted adjacent to the exterior head cover 21, opposite to the first lateral surface 113. Thus positioned, the interior head member 22 forms the aesthetically pleasing upper rail for the interior portion of the frame around the sash assembly 1.

As can be seen in FIG. 1, FIG. 3, and FIG. 9, as described above, the frame head 2 is designed to be a two-piece component with the exterior head cover 21 being used as a weather guard and drainage system that protects the interior head member 22. To accomplish this, the exterior head cover 21 comprises a first head bracket 211, a second head bracket 212, and a head beam 213. Furthermore, the interior head member 22 comprises a first head leg 221 and a second head leg 222. A cross-sectional view of the exterior head cover 21 shows the exterior head cover 21 to be formed into a Z-shaped member. As such, the first head bracket 211 forms a first leg of the Z-shaped member, the head beam 213 forms the central connecting leg of the Z-shaped member, and the second head bracket 212 forms the second leg of the Z-shaped member. Specifically, the first head bracket 211 is terminally connected to the head beam 213. Furthermore, the second head bracket 212 is terminally connected to the head beam 213, opposite to the first head bracket 211. Moreover, the first head bracket 211 is oriented parallel to the second head bracket 212. Finally, the first head bracket 211 and the second head bracket 212 are oriented opposite to each other. Consequently, the exterior head cover 21 is able to form a component that structurally supports the interior head member 22 while protecting the interior head member 22 from the external environment. A cross-sectional view of the interior head member 22 shows the interior head member 22 to be formed into an L-shaped member. As such, the first head leg 221 forms a first leg of the L-shaped member, the second head leg 222 forms second leg of the L-shaped member. To capitalize on this configuration, the first head bracket 211 is terminally connected to the first head leg 221. Additionally, the first head leg 221 is positioned along the head beam 213. As a result, the first head leg 221 is supported by the head beam 213, such that the first head bracket 211 and the head beam 213 prevent the first head leg 221 from coming into contact with the external environment. Additionally, the first head leg 221 is sandwiched between the head beam 213 and the building structure into which the present invention is integrated. The second head leg 222 is connected adjacent and perpendicular to the first head leg 221, opposite to the first head bracket 211. Accordingly, the second head leg 222 forms the aesthetically pleasing interior-facing side of the interior head member 22. Finally, the second head bracket 212 is connected along the second head leg 222 so that the second bracket is able to provide structural support for the second head leg 222.

As can be seen in FIG. 1, FIG. 3, and FIG. 9, the frame sill 3 is manufactured as a multicomponent assembly that promotes durability, thermal insulation, and aesthetic desirability of the present invention. To accomplish this, the exterior sill cover 31 is mounted adjacent to a second lateral surface 114 of the external sash frame 11. Consequently, the exterior sill cover 31 is able to function as a durable and weatherproof support structure that forms the bottom rail for the exterior portion of the frame around the sash assembly 1. The interior sill member 32 is mounted adjacent to the exterior sill cover 31, opposite to the second lateral surface 114. Thus positioned, the interior sill member 32 forms the aesthetically pleasing bottom rail for the interior portion of the frame around the sash assembly 1.

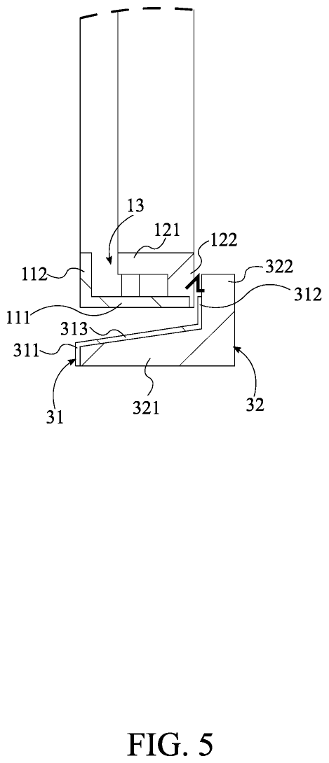

As can be seen in FIG. 1, FIG. 5, and FIG. 9, as described above, the frame sill 3 is designed to be a two-piece component with the exterior sill cover 31 being the support structure for the interior sill member 32. To accomplish this, the exterior sill cover 31 comprises a first sill bracket 311, a second sill bracket 312, and a sill beam 313. Furthermore, the interior sill member 32 comprises a first sill leg 321 and a second leg 322. A cross-sectional view of the exterior sill cover 31 shows the exterior sill cover 31 to be formed into a Z-shaped member. As such, the first sill bracket 311 forms a first leg of the Z-shaped member, the sill beam 313 forms the central connecting leg of the Z-shaped member, and the second sill bracket 312 forms the second leg of the Z-shaped member. Specifically, the first sill bracket 311 is terminally connected to the sill beam 313. Furthermore, the second sill bracket 312 is terminally connected to the sill beam 313, opposite to the first sill bracket 311. Moreover, the first sill bracket 311 is oriented parallel to the second sill bracket 312. Finally, the first sill bracket 311 and the second sill bracket 312 are oriented opposite to each other. Consequently, the exterior sill cover 31 is able to form a component that structurally supports the interior sill member 32 while protecting the interior sill member 32 from the external environment. A cross-sectional view of the interior sill member 32 shows the interior sill member 32 to be formed into an L-shaped member. As such, the first sill leg 321 forms a first leg of the L-shaped member, the second leg 322 forms second leg of the L-shaped member. To capitalize on this configuration, the first sill bracket 311 is terminally connected to the first sill leg 321. Additionally, the first sill leg 321 is positioned along the sill beam 313. As a result, the first sill leg 321 is supported by the sill beam 313, such that the first sill bracket 311 and the sill beam 313 prevents the first sill leg 321 from coming into contact with the external environment. Additionally, the first sill leg 321 is sandwiched between the sill beam 313 and the building structure into which the present invention is integrated. The second leg 322 is connected adjacent and perpendicular to the first sill leg 321, opposite to the first sill bracket 311. Accordingly, the second leg 322 forms the aesthetically pleasing interior-facing side of the interior sill member 32. Finally, the second sill bracket 312 is connected along the second leg 322 so that the second bracket is able to provide structural support for the second leg 322.

As can be seen in FIG. 1, FIG. 3, and FIG. 9, the frame jamb 4 is manufactured as a multicomponent assembly that promotes durability, thermal insulation, and aesthetic desirability of the present invention. To accomplish this, the exterior jamb cover 41 is mounted adjacent to a third lateral surface 115 of the external sash frame 11. Consequently, the exterior jamb cover 41 is able to function as a durable and weatherproof support structure that forms the vertical support beam for the exterior portion of the frame around the sash assembly 1. The interior jamb member 42 is mounted adjacent to the exterior jamb cover 41, opposite to the second lateral surface 114. Thus positioned, the interior jamb member 42 forms the aesthetically pleasing vertical support beam for the interior portion of the frame around the sash assembly 1.

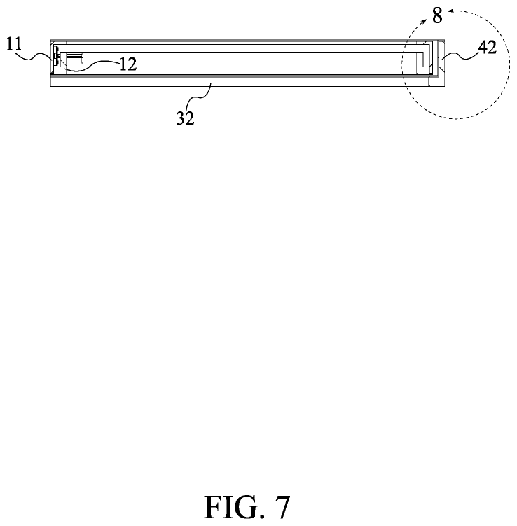

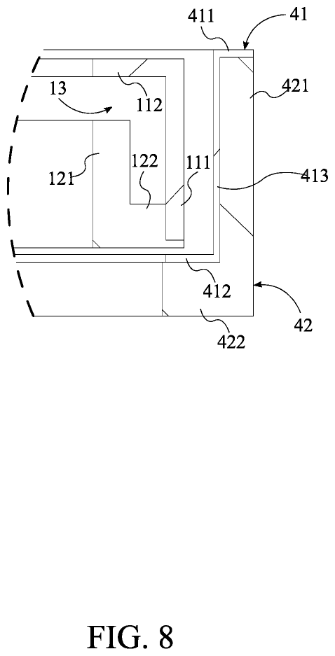

As can be seen in FIG. 1, FIG. 7, FIG. 8, and FIG. 9, as described above, the frame jamb 4 is designed to be a two-piece component with the exterior jamb cover 41 being the support structure for the interior jamb member 42. To accomplish this, the exterior jamb cover 41 comprises a first jamb bracket 411, a second jamb bracket 412, and a jamb beam 413. Furthermore, the interior jamb member 42 comprises a first jamb leg 421 and a second jamb leg 422. A cross-sectional view of the exterior jamb cover 41 shows the exterior jamb cover 41 to be formed into a Z-shaped member. As such, the first jamb bracket 411 forms a first leg of the Z-shaped member, the jamb beam 413 forms the central connecting leg of the Z-shaped member, and the second jamb bracket 412 forms the second leg of the Z-shaped member. Specifically, the first jamb bracket 411 is terminally connected to the jamb beam 413. Furthermore, the second jamb bracket 412 is terminally connected to the jamb beam 413, opposite to the first jamb bracket 411. Moreover, the first jamb bracket 411 is oriented parallel to the second jamb bracket 412. Finally, the first jamb bracket 411 and the second jamb bracket 412 are oriented opposite to each other. Consequently, the exterior jamb cover 41 is able to form a component that structurally supports the interior jamb member 42 while protecting the interior jamb member 42 from the external environment. A cross-sectional view of the interior jamb member 42 shows the interior jamb member 42 to be formed into an L-shaped member. As such, the first jamb leg 421 forms a first leg of the L-shaped member, the second jamb leg 422 forms second leg of the L-shaped member. To capitalize on this configuration, the first jamb bracket 411 is terminally connected to the first jamb leg 421. Additionally, the first jamb leg 421 is positioned along the jamb beam 413. As a result, the first jamb leg 421 is supported by the jamb beam 413, such that the first jamb bracket 411 and the jamb beam 413 prevents the first jamb leg 421 from coming into contact with the external environment. Additionally, the first jamb leg 421 is sandwiched between the jamb beam 413 and the building structure into which the present invention is integrated. The second jamb leg 422 is connected adjacent and perpendicular to the first jamb leg 421, opposite to the first jamb bracket 411. Accordingly, the second jamb leg 422 forms the aesthetically pleasing interior-facing side of the interior jamb member 42. Finally, the second jamb bracket 412 is connected along the second jamb leg 422 so that the second bracket is able to provide structural support for the second jamb leg 422.

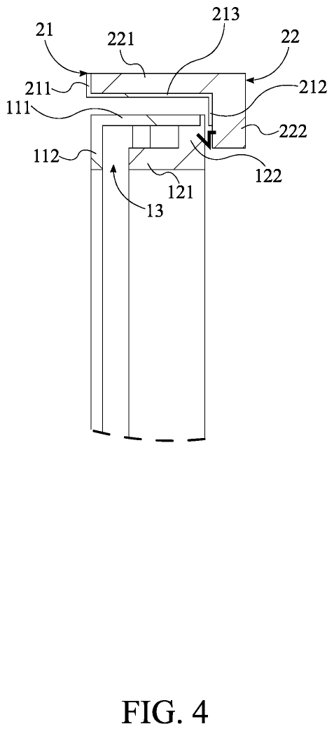

As can be seen in FIG. 1, FIG. 4, and FIG. 9, as an example, the sash assembly 1 can be manufactured as a rectangular frame around the pane of glass. In this example, the first lateral surface 113 is the top side of the rectangular frame, as such the frame head 2 is mounted adjacent to the top side of the rectangular frame. Continuing this example, the second lateral surface 114 is the bottom side of the rectangular frame, as such the frame sill 3 is mounted adjacent to the bottom side of the rectangular frame. Finally, the third lateral surface 115 can be either the left or right side of the rectangular frame, as such the frame jamb 4 is mounted adjacent to the left or right side of the rectangular frame. This configuration enables the present invention to be used in various types of windows and doors including, but not limited to, French doors, casement windows, sliding doors, and bi-folding doors. In a first alternative embodiment, a second frame jamb 4 is mounted adjacent to a fourth lateral surface of the sash frame, opposite to the frame jamb 4. In this embodiment, the rectangular sash assembly 1 is surrounded by a rectangular frame. Additionally, any of the lateral surfaces of the rectangular sash assembly 1 can be hingedly mounted onto a corresponding frame head 2, frame sill 3, or frame jamb 4 to enable the present invention to function as a French window or door, an awning window, or a hopper window.

As can be seen in FIG. 1, FIG. 4, and FIG. 9, to fully describe the components of the sash assembly 1, it must be stated that the external sash frame 11 comprises a lateral sash portion 111 and a planar sash portion 112. Additionally, it must be stated that the thermal-stop glazing bead frame 12 comprises a lateral bead portion 121 and a planar bead portion 122. The external sash frame 11 and the thermal-stop glazing bead frame 12 are preferably rectangular frames, and taking a cross-sectional view of the sash frame and the thermal-stop glazing bead frame 12 shows each supporting member to be formed into a corresponding L-shaped member. As such, the lateral sash portion 111 forms a first leg of the corresponding L-shaped member. Furthermore, the planar sash portion 112 forms a second leg of the corresponding L-shaped member. The current aspect ratio of the first and second legs of the external sash frame 11 is preferably 2.46:1. Similarly, the lateral bead portion 121 forms a first leg of the corresponding L-shaped member. Furthermore, the planar bead portion 122 forms a second leg of the corresponding L-shaped member. Specifically, the lateral sash portion 111 is perimetrically connected to the planar sash portion 112. Additionally, the lateral sash portion 111 is positioned perpendicular to the planar sash portion 112. Thus positioned, the planar sash portion 112 and the lateral sash portion 111 form a frame with an L-shaped cross-sectional profile. Similarly, the lateral bead portion 121 is perimetrically connected to the planar bead portion 122. Additionally, the lateral bead portion 121 is positioned perpendicular to the planar bead portion 122. Thus positioned, the planar bead portion 122 and the lateral bead portion 121 form a frame with an L-shaped cross-sectional profile.

As can be seen in FIG. 1, FIG. 4, and FIG. 9, the L-shaped profiles of the external sash frame 11 and the thermal-stop glazing bead frame 12 enable the sash assembly 1 to retain the pane of glass in an orientation that promotes structural integrity while facilitating thermal isolation. To accomplish this, the planar bead portion 122 is mounted within the lateral sash portion 111. As a result, the lateral sash portion 111 is able to support the planar bead portion 122 while protecting the planar bead portion 122 from harmful elements in the external environment. The lateral bead portion 121 is oriented toward the planar sash portion 112. Furthermore, the lateral bead portion 121 is positioned offset from the planar sash portion 112 by the glass-receiving gap 13. Consequently, the lateral bead portion 121 is used to press the pane of glass, that is inserted into the glass-receiving gap 13, against the planar sash portion 112. The present invention is designed to provide a sash assembly 1 with increased structural strength. As such, the present invention comprises a planar reinforcement frame 5. The planar reinforcement frame 5 is a rigid frame that is formed in the same shape as the external sash frame 11. Additionally, the planar reinforcement frame 5 is perimetrically connected to the planar sash portion 112. Accordingly, the planar reinforcement frame 5 bolsters the structural rigidity of the external sash frame 11.

As can be seen in FIG. 1, FIG. 3, FIG. 4, and FIG. 9, as described above, the frame head 2 is designed to be a two-piece component with the exterior head cover 21 being the support structure for the interior head member 22. To accomplish this, the exterior head cover 21 comprises a first head bracket 211, a second head bracket 212, and a head beam 213. Furthermore, the interior head member 22 comprises a first head leg 221 and a second head leg 222. A cross-sectional view of the exterior head cover 21 shows the exterior head cover 21 to be formed into a Z-shaped member. As such, the first head bracket 211 forms a first leg of the Z-shaped member, the head beam 213 forms the central connecting leg of the Z-shaped member, and the second head bracket 212 forms the second leg of the Z-shaped member. Specifically, the first head bracket 211 is terminally connected to the head beam 213. Furthermore, the second head bracket 212 is terminally connected to the head beam 213, opposite to the first head bracket 211. Moreover, the first head bracket 211 is oriented parallel to the second head bracket 212. Finally, the first head bracket 211 and the second head bracket 212 are oriented opposite to each other. Consequently, the exterior head cover 21 is able to form a component that structurally supports the interior head member 22 while protecting the interior head member 22 from the external environment. A cross-sectional view of the interior head member 22 shows the interior head member 22 to be formed into an L-shaped member. As such, the first head leg 221 forms a first leg of the L-shaped member, the second head leg 222 forms second leg of the L-shaped member. To capitalize on this configuration, the first head bracket 211 is terminally connected to the first head leg 221. Additionally, the first head leg 221 is positioned along the head beam 213. As a result, the first head leg 221 is supported by the head beam 213, such that the first head bracket 211 and the head beam 213 prevent the first head leg 221 from coming into contact with the external environment. Additionally, the first head leg 221 is sandwiched between the head beam 213 and the building structure into which the present invention is integrated. The second head leg 222 is connected adjacent and perpendicular to the first head leg 221, opposite to the first head bracket 211. Accordingly, the second head leg 222 forms the aesthetically pleasing interior-facing side of the interior head member 22. Finally, the second head bracket 212 is connected along the second head leg 222 so that the second bracket is able to provide structural support for the second head leg 222.

As can be seen in FIG. 1, FIG. 5, and FIG. 9, as described above, the frame sill 3 is designed to be a two-piece component with the exterior sill cover 31 being the support structure for the interior sill member 32. To accomplish this, the exterior sill cover 31 comprises a first sill bracket 311, a second sill bracket 312, and a sill beam 313. Furthermore, the interior sill member 32 comprises a first sill leg 321 and a second leg 322. A cross-sectional view of the exterior sill cover 31 shows the exterior sill cover 31 to be formed into a Z-shaped member. As such, the first sill bracket 311 forms a first leg of the Z-shaped member, the sill beam 313 forms the central connecting leg of the Z-shaped member, and the second sill bracket 312 forms the second leg of the Z-shaped member. Specifically, the first sill bracket 311 is terminally connected to the sill beam 313. Furthermore, the second sill bracket 312 is terminally connected to the sill beam 313, opposite to the first sill bracket 311. Moreover, the first sill bracket 311 is oriented parallel to the second sill bracket 312. Finally, the first sill bracket 311 and the second sill bracket 312 are oriented opposite to each other. Consequently, the exterior sill cover 31 is able to form a component that structurally supports the interior sill member 32 while protecting the interior sill member 32 from the external environment. A cross-sectional view of the interior sill member 32 shows the interior sill member 32 to be formed into an L-shaped member. As such, the first sill leg 321 forms a first leg of the L-shaped member, the second leg 322 forms second leg of the L-shaped member. To capitalize on this configuration, the first sill bracket 311 is terminally connected to the first sill leg 321. Additionally, the first sill leg 321 is positioned along the sill beam 313. As a result, the first sill leg 321 is supported by the sill beam 313, such that the first sill bracket 311 and the sill beam 313 prevents the first sill leg 321 from coming into contact with the external environment. Additionally, the first sill leg 321 is sandwiched between the sill beam 313 and the building structure into which the present invention is integrated. The second leg 322 is connected adjacent and perpendicular to the first sill leg 321, opposite to the first sill bracket 311. Accordingly, the second leg 322 forms the aesthetically pleasing interior-facing side of the interior sill member 32. Finally, the second sill bracket 312 is connected along the second leg 322 so that the second bracket is able to provide structural support for the second leg 322.

As can be seen in FIG. 1, FIG. 7, FIG. 8, and FIG. 9, as described above, the frame jamb 4 is designed to be a two-piece component with the exterior jamb cover 41 being the support structure for the interior jamb member 42. To accomplish this, the exterior jamb cover 41 comprises a first jamb bracket 411, a second jamb bracket 412, and a jamb beam 413. Furthermore, the interior jamb member 42 comprises a first jamb leg 421 and a second jamb leg 422. A cross-sectional view of the exterior jamb cover 41 shows the exterior jamb cover 41 to be formed into a Z-shaped member. As such, the first jamb bracket 411 forms a first leg of the Z-shaped member, the jamb beam 413 forms the central connecting leg of the Z-shaped member, and the second jamb bracket 412 forms the second leg of the Z-shaped member. Specifically, the first jamb bracket 411 is terminally connected to the jamb beam 413. Furthermore, the second jamb bracket 412 is terminally connected to the jamb beam 413, opposite to the first jamb bracket 411. Moreover, the first jamb bracket 411 is oriented parallel to the second jamb bracket 412. Finally, the first jamb bracket 411 and the second jamb bracket 412 are oriented opposite to each other. Consequently, the exterior jamb cover 41 is able to form a component that structurally supports the interior jamb member 42 while protecting the interior jamb member 42 from the external environment. A cross-sectional view of the interior jamb member 42 shows the interior jamb member 42 to be formed into an L-shaped member. As such, the first jamb leg 421 forms a first leg of the L-shaped member, the second jamb leg 422 forms second leg of the L-shaped member. To capitalize on this configuration, the first jamb bracket 411 is terminally connected to the first jamb leg 421. Additionally, the first jamb leg 421 is positioned along the jamb beam 413. As a result, the first jamb leg 421 is supported by the jamb beam 413, such that the first jamb bracket 411 and the jamb beam 413 prevents the first jamb leg 421 from coming into contact with the external environment. Additionally, the first jamb leg 421 is sandwiched between the jamb beam 413 and the building structure into which the present invention is integrated. The second jamb leg 422 is connected adjacent and perpendicular to the first jamb leg 421, opposite to the first jamb bracket 411. Accordingly, the second jamb leg 422 forms the aesthetically pleasing interior-facing side of the interior jamb member 42. Finally, the second jamb bracket 412 is connected along the second jamb leg 422 so that the second bracket is able to provide structural support for the second jamb leg 422.

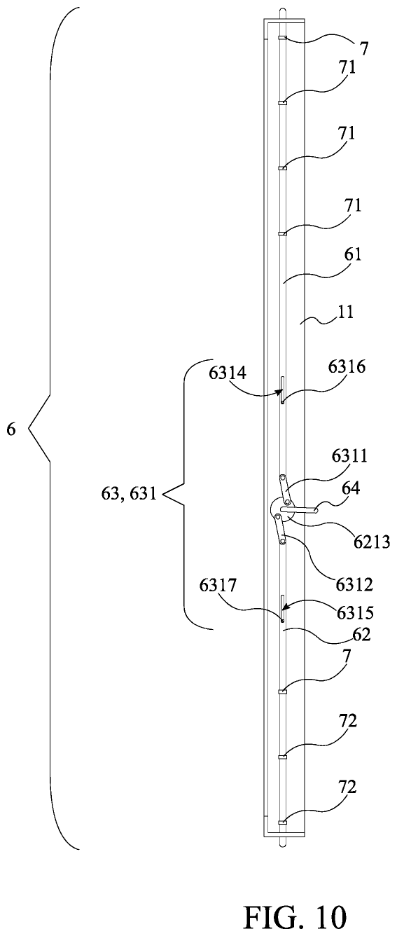

As can be seen in FIG. 1, FIG. 9, and FIG. 10, the present invention is designed with a locking mechanism that is integrated into the sash assembly 1. This locking mechanism enables the sash assembly 1 to be locked in a closed configuration without the need for an independent locking system. To accomplish this, the present invention comprises an internal cremone 6, a head lock hole 8, and a sill lock hole 9. The internal cremone 6 functions as the internal locking mechanism and enables the user to engage and disengage the internal locking mechanism as desired. To accomplish this, the internal cremone 6 comprises a head lock bar 61, a sill lock bar 62, and a linear actuator 63. The head lock bar 61 and the sill lock bar 62 are rigid bars that function as locking bolts which enable the user to lock the sash assembly 1 in the closed configuration. The head lock hole 8 traverses through the external sash frame 11 toward the first lateral 113 surface so that the head lock bar 61 is able to pass through the external sash frame 11. Similarly, the sill lock hole 9 traverses through the external sash frame 11 toward the second lateral surface 114 so that the sill lock bar 62 is able to pass through the external sash frame 11. Furthermore, the head lock bar 61 is slidably engaged through the head lock hole 8. Consequently, a portion of the head lock bar 61 is able to slide into and out of the external sash frame 11 when being used as a lock bolt to lock the sash assembly 1 in the closed configuration. Similarly, the sill lock bar 62 is slidably engaged through the sill lock hole 9. Consequently, a portion of the sill lock bar 62 is able to slide into and out of the external sash frame 11 when being used as a lock bolt to lock the sash assembly 1 in the closed configuration. The linear actuator 63 is a mechanical device that is used to slide the head lock bar 61 through the head lock hole 8 and to slide the sill lock bar 62 through the sill lock hole 9. As such, the linear actuator 63 is mounted within the external sash frame 11. Additionally, the head lock bar 61 is terminally connected to the linear actuator 63. Furthermore, the sill lock bar 62 is terminally connected to the linear actuator 63, opposite to the head lock bar 61. As a result, the linear actuator 63 is used to extend a portion of the head lock bar 61 and the sill lock bar 62 out of the external sash frame 11 when the sash assembly 1 is locked in the locked configuration. Conversely, the linear actuator 63 is used to retract a portion of the head lock bar 61 and the sill lock bar 62 into the external sash frame 11 when the sash assembly 1 is released from the locked configuration. In the first alternative embodiment of the present invention, the internal cremone 6, the head lock hole 8, and the sill lock hole 9 are reoriented to enable the present invention to function as a lockable French window or door, awning window, or hopper window.

As can be seen in FIG. 1, FIG. 9, and FIG. 10, the head lock bar 61 and the sill lock bar 62 are prevented from becoming misaligned with the head lock hole 8 and the sill lock hole 9 through the use of rod guides. To accomplish this, the present invention comprises a plurality of rod guides 7. Each of the plurality of rod guides 7 is an eyelet that is used to direct the path of the head lock bar 61 and the sill lock bar 62. As such, the plurality of rod guides 7 is distributed along the external sash frame 11. So that the plurality of rod guides 7 form a raceway for the head lock rod and the sill lock rod. Specifically, the head lock bar 61 is slidably engaged through a first plurality of guides 71, wherein the first plurality of guides 71 is from the plurality of rod guides 7. As a result, the head lock rod is concentrically aligned with the head lock hole 8. Similarly, the sill lock bar 62 is slidably engaged through a second plurality of guides 72, wherein the second plurality of guides 72 is from the plurality of rod guides 7. Consequently, the sill lock bar 62 is concentrically aligned with sill lock hole 9.

As can be seen in FIG. 1, FIG. 9, and FIG. 10, in the preferred embodiment of the present invention, the linear actuator 63 is an orbital linkage mechanism 631. The orbital linkage mechanism 631 is a linear actuator 63 that uses coupling rods to transform the rotation of a drive disk into linear motion. To accomplish this, the orbital linkage mechanism 631 comprises a first linkage 6311, a second linkage 6312, a lock drive disk 6313, and a first lever 64. The first linkage 6311 and the second linkage 6312 are coupling rods. Specifically, the head lock bar 61 is terminally and pivotably connected to the first linkage 6311 so that the first linkage 6311 is able to actuate the head lock bar 61. Similarly, the sill lock bar 62 is terminally and pivotably connected to the second linkage 6312 so that the second linkage 6312 is able to actuate the sill lock bar 62. The lock drive disk 6313 is the driving wheel that is used to actuate the first linkage 6311 and the second linkage 6312. As such, the lock drive disk 6313 is terminally and pivotably connected to the first linkage 6311, opposite to the head lock bar 61. Additionally, the lock drive disk 6313 is terminally and pivotably connected to the second linkage 6312, opposite to the sill lock bar 62. Thus connected, rotation of the lock drive disk 6313 is transferred to the first linkage 6311, the second linkage 6312, and subsequently to the head lock bar 61 and the sill lock bar 62. The first lever 64 is torsionally connected to the lock drive disk 6313 so that rotating the first lever 64 rotates the lock drive disk 6313. Thus, actuating the head lock bar 61 and the sill lock bar 62. Furthermore, the first lever 64 is positioned in between the first linkage 6311 and the second linkage 6312. As a result, the first lever 64 is able to supply equal amounts of torque to the first linkage 6311 and the second linkage 6312.

As can be seen in FIG. 1, FIG. 9, and FIG. 10, the present invention is designed with detents that limit the distance which the head lock bar 61 and the sill lock bar 62 can be displaced by the orbital linkage mechanism 631. To accomplish this, the orbital linkage mechanism 631, further comprises a first retainer slot 6314, a second retainer slot 6315, first lock bar retainer 6316, and a second lock bar retainer 6317. Specifically, the first retainer slot 6314 traverses through the head lock bar 61. Additionally, the first retainer slot 6314 is positioned along the head lock bar 61. As a result, the first retainer slot 6314 forms a track that delineates the maximum distance that the head lock bar 61 can be displaced. Similarly, the second retainer slot 6315 traverses through the sill lock bar 62. Additionally, the second retainer slot 6315 is positioned along the sill lock bar 62. As a result, the second retainer slot 6315 forms a track that delineates the maximum distance that the sill lock bar 62 can be displaced. The first lock bar retainer 6316 and the second lock bar retainer 6317 are rigid pegs. Moreover, the first lock bar retainer 6316 is connected adjacent to the external sash frame 11 so that the first lock bar retainer 6316 is maintained in a position that facilitates limiting the distance that the head lock bar 61 is able to be displaced. Additionally, the first lock bar retainer 6316 is slidably engaged along the first retainer slot 6314. As a result, the first lock bar retainer 6316 slides along the first retainer slot 6314 as the head lock bar 61 is displaced by the first linkage 6311. Similarly, the second lock bar retainer 6317 is connected adjacent to the external sash frame 11 so that the second lock bar retainer 6317 is maintained in a position that facilitates limiting the distance that the sill lock bar 62 is able to be displaced. Additionally, the second lock bar retainer 6317 is slidably engaged along the second retainer slot 6315. As a result, the second lock bar retainer 6317 slides along the second retainer slot 6315 as the sill lock bar 62 is displaced by the second linkage 6312.

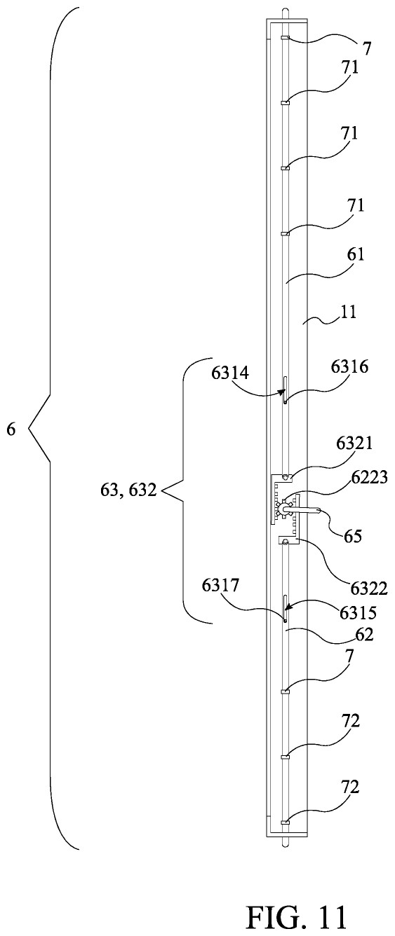

As can be seen in FIG. 1, FIG. 9, and FIG. 11, in the first alternative embodiment of the present invention, the linear actuator 63 is a rack and pinion mechanism 632. As such, the rack and pinion mechanism 632 comprises a first rack 6321, a second rack 6322, a pinion 6323, and a second lever 65. The first rack 6321 is terminally connected to the head lock bar 61. Conversely, the second rack 6322 is terminally connected to the sill lock bar 62. Additionally, the pinion 6323 is engaged in between the first rack 6321 and the second rack 6322. As a result, the rack and pinion mechanism 632 is able to extend and retract the head lock bar 61 and the sill lock bar 62 out of and then into the sash assembly 1. To accomplish this, the second lever 65 is torsionally connected to the pinion 6323. As a result, rotating the second lever 65 rotates the pinion 6323 and actuates the head lock bar 61 and the sill lock bar 62.

Although the invention has been explained in relation to its preferred embodiment, it is to be understood that many other possible modifications and variations can be made without departing from the spirit and scope of the invention as hereinafter claimed.

What is claimed is:

1. A composite sash and frame for windows and doors comprises:
a sash assembly;
a frame head;
a frame sill;
a frame jamb;
the sash assembly comprises an external sash frame and a thermal-stop glazing bead frame;
the frame head comprises an exterior head cover and an interior head member;
the frame sill comprises an exterior sill cover and an interior sill member;
the frame jamb comprises an exterior jamb cover and an interior jamb member;
the thermal-stop glazing bead frame being perimetrically mounted within the external sash frame;
a glass-receiving gap being integrated in between the external sash frame and the thermal-stop glazing bead frame;
the frame head being mounted adjacent to a first lateral surface of the external sash frame;
the frame sill being mounted adjacent to a second lateral surface of the external sash frame, opposite to the exterior head cover;
the exterior jamb cover being positioned in between the first lateral surface and the second lateral surface; and
the frame jamb being mounted adjacent to a third lateral surface of the external sash frame.

2. The composite sash and frame for windows and doors as claimed in claim 1 comprises:
the exterior head cover being mounted adjacent to the first lateral surface of the external sash frame; and
the interior head member being mounted adjacent to the exterior head cover, opposite to the first lateral surface.

3. The composite sash and frame for windows and doors as claimed in claim 2 comprises:
the exterior head cover comprises a first head bracket, a second head bracket, and a head beam;
the interior head member comprises a first head leg and a second head leg;
the first head bracket being terminally connected to the head beam;
the second head bracket being terminally connected to the head beam, opposite to the first head bracket;
the first head bracket being oriented parallel to the second head bracket;
the first head bracket and the second head bracket being oriented opposite to each other;
the first head bracket being terminally connected to the first head leg;
the first head leg being positioned along the head beam;
the second head leg being connected adjacent and perpendicular to the first head leg, opposite to the first head bracket; and
the second head bracket being connected along the second head leg.

4. The composite sash and frame for windows and doors as claimed in claim 1 comprises:
the exterior sill cover being mounted adjacent to the second lateral surface of the external sash frame, opposite to the exterior head cover; and
the interior sill member being mounted adjacent to the exterior sill cover, opposite to the second lateral surface.

5. The composite sash and frame for windows and doors as claimed in claim 4 comprises:
the exterior sill cover comprises a first sill bracket, a second sill bracket, and a sill beam;
the interior sill member comprises a first sill leg and a second sill leg;
the first sill bracket being terminally connected to the sill beam;
the second sill bracket being terminally connected to the sill beam, opposite to the first sill bracket;
the first sill bracket being oriented parallel to the second sill bracket;
the first sill bracket and the second sill bracket being oriented opposite to each other;
the first sill bracket being terminally connected to the first sill leg;
the first sill leg being positioned along the sill beam;
the second sill leg being connected adjacent and perpendicular to the first sill leg, opposite to the first sill bracket; and
the second sill bracket being connected along the second sill leg.

6. The composite sash and frame for windows and doors as claimed in claim 1 comprises:
the exterior jamb cover being mounted adjacent to the third lateral surface of the external sash frame; and
the interior jamb member being mounted adjacent to the exterior jamb cover, opposite to the third lateral surface.

7. The composite sash and frame for windows and doors as claimed in claim 6 comprises:
the exterior jamb cover comprises a first jamb bracket, a second jamb bracket, and a jamb beam;
the interior jamb member comprises a first jamb leg and a second jamb leg;
the first jamb bracket being terminally connected to the jamb beam;
the second jamb bracket being terminally connected to the jamb beam, opposite to the first jamb bracket;
the first jamb bracket being oriented parallel to the second jamb bracket;
the first jamb bracket and the second jamb bracket being oriented opposite to each other;
the first jamb bracket being terminally connected to the first jamb leg;
the first jamb leg being positioned along the jamb beam;
the second jamb leg being connected adjacent and perpendicular to the first jamb leg, opposite to the first jamb bracket; and
the second jamb bracket being connected along the second jamb leg.

8. The composite sash and frame for windows and doors as claimed in claim 1 comprises:
the external sash frame comprises a lateral sash portion and a planar sash portion;
the thermal-stop glazing bead frame comprises a lateral bead portion and a planar bead portion;
the lateral sash portion being perimetrically connected to the planar sash portion;
the lateral sash portion being positioned perpendicular to the planar sash portion;
the lateral bead portion being perimetrically connected to the planar bead portion;
the lateral bead portion being positioned perpendicular to the planar bead portion;
the planar bead portion being mounted within the lateral sash portion;
the lateral bead portion being oriented toward the planar sash portion; and
the lateral bead portion being positioned offset from the planar sash portion by the glass-receiving gap.

9. The composite sash and frame for windows and doors as claimed in claim 8 comprises:
a planar reinforcement frame; and
the planar reinforcement frame being perimetrically connected to the planar sash portion.

10. The composite sash and frame for windows and doors as claimed in claim 1 comprises:
an internal cremone;
a head lock hole;
a sill lock hole;
the internal cremone comprises a head lock bar, a sill lock bar, and a linear actuator;
the head lock hole traversing through the external sash frame toward the first lateral surface;
the sill lock hole traversing through the external sash frame toward the second lateral surface;
the head lock bar being slidably engaged through the head lock hole;
the sill lock bar being slidably engaged through the sill lock hole;
the linear actuator being mounted within the external sash frame;
the head lock bar being terminally connected to the linear actuator; and
the sill lock bar being terminally connected to the linear actuator, opposite to the head lock bar.

11. The composite sash and frame for windows and doors as claimed in claim 10 comprises:
a plurality of rod guides;
the plurality of rod guides being distributed along the external sash frame;
the head lock bar being slidably engaged through a first plurality of guides, wherein the first plurality of guides is from the plurality of rod guides; and
the sill lock bar being slidably engaged through a second plurality of guides, wherein the second plurality of guides is from the plurality of rod guides.

12. The composite sash and frame for windows and doors as claimed in claim 10 comprises:
the linear actuator being an orbital linkage mechanism;
the orbital linkage mechanism comprises a first linkage, a second linkage, a lock drive disk, and a first lever;
the head lock bar being terminally and pivotably connected to the first linkage;
the sill lock bar being terminally and pivotably connected to the second linkage;
the lock drive disk being terminally and pivotably connected to the first linkage, opposite to the head lock bar;
the lock drive disk being terminally and pivotably connected to the second linkage, opposite to the sill lock bar;
the first lever being torsionally connected to the lock drive disk; and
the first lever being positioned in between the first linkage and the second linkage.

13. The composite sash and frame for windows and doors as claimed in claim 10 comprises:
the linear actuator being an orbital linkage mechanism;
the orbital linkage mechanism further comprises a first retainer slot, a second retainer slot, first lock bar retainer, and a second lock bar retainer;
the first retainer slot traversing through the head lock bar;
the first retainer slot being positioned along the head lock bar;
the second retainer slot traversing through the sill lock bar;
the second retainer slot being positioned along the sill lock bar;
the first lock bar retainer being connected adjacent to the external sash frame;
the first lock bar retainer being slidably engaged along the first retainer slot;
the second lock bar retainer being connected adjacent to the external sash frame; and
the second lock bar retainer being slidably engaged along the second retainer slot.

14. The composite sash and frame for windows and doors as claimed in claim 10 comprises:
the linear actuator being a rack and pinion mechanism;
the rack and pinion mechanism comprises a first rack, a second rack, and a pinion, and a second lever;
the first rack being terminally connected to the head lock bar;
the second rack being terminally connected to the sill lock bar;
the pinion being engaged in between the first rack and the second rack; and
the second lever being torsionally connected to the pinion.

15. The composite sash and frame for windows and doors as claimed in claim 1, wherein the thermal-stop glazing bead frame, the interior head member, the interior sill member, and the interior jamb member are made of wood.

16. The composite sash and frame for windows and doors as claimed in claim 1, wherein the external sash frame, the exterior head cover, the exterior sill cover, and the exterior jamb cover are made of steel.
